(19) United States
(12) Patent Application Publication
(10) Pub. No.: US 2006/0105170 A1
(43) Pub. Date: May 18, 2006

(54) Magnetic particle and process for preparation

(75) Inventors: Peter James Dobson, Oxford (GB); Robin Nicholas Taylor, Radlett (GB)

Correspondence Address: SUGHRUE MION, PLLC, 2100 PENNSYLVANIA AVENUE, N.W., SUITE 800, WASHINGTON, DC, 20037, US

(73) Assignee: Isis Innovation Limited, Oxford (GB)

(21) Appl. No.: 10/525,466

(22) PCT Filed: Aug. 29, 2003
(86) PCT No.: PCT/GB03/03748

§ 371 Date: Sep. 13, 2005

(30) Foreign Application Priority Data
Aug. 29, 2002 (GB) 0220063.2

(51) Int. Cl. H01F 1/00

(52) U.S. Cl. 428/403; 252/62.51 R; 252/62.55; 252/62.56; 252/62.54; 252/301.4 R

(57) ABSTRACT

A particle is disclosed which comprises a core surrounded by a shell which comprises a plurality of nanoparticles of a magnetic material, the shell being surrounded by a continuous outer shell which comprises a non-magnetic material. The particle can be prepared by a process comprising: a first step of providing a core; a second step of adsorbing an inner shell to the core; a third step of providing a plurality of nanoparticles of a magnetic material; a fourth step of adsorbing the nanoparticles to the inner shell; and a fifth step of synthesising an outer shell surrounding the particle. The particle can exhibit the effective bulk properties of a superparamagnetic particle, and the effective surface properties of a non-magnetic particle.

The present invention relates to composite magnetic particles and to a process for preparation thereof.

Superparamagnetic nanoparticles are known which comprise small particles of ferromagnetic or ferrimagnetic material. The superparamagnetic effect manifests itself as a thermally-activated rotation of the magnetic dipole of such particles within a particular time frame of interest. In order to be superparamagnetic, a magnetic particle has to have a diameter of less than about 10 to 20 nm, depending on the particle morphology and magnetic anisotropy of the material in question. Thus there has been a constraint on the choice of particle size that can be obtained. It has been known to use a magnetic nanoparticle as the core of a larger particle, but this greatly reduces the magnetic response. Thus there are problems with tailoring the desired physical properties of magnetic particles, such as their surface properties, size and magnetic properties. Previously, there have also been problems in avoiding agglomeration during preparation of such particles.

It is an object of the present invention to alleviate, at least partially, any of the above problems.

Accordingly, the present invention provides a particle comprising a core surrounded by a shell which comprises a plurality of nanoparticles of a magnetic material, the shell being surrounded by a continuous outer shell which comprises a non-magnetic material. The fact that a plurality of magnetic nanoparticles form the shell surrounding a core means that the magnetic properties of the nanoparticles are retained such that the overall particle has the effective bulk properties of a superparamagnetic particle, and the magnetic response is much stronger than a particle of the same size with just a magnetic nanoparticle as the core. This structure also has the feature that tuning of the core size and shell thickness allows a modulation of the magnetic behaviour of the overall particle.

Thermal relaxation of the magnetic moment of the nanoparticles forming the shell means that they exhibit the superparamagnetic effect at ambient conditions. When these nanoparticles are used to form a shell of a particle according to the invention, it is possible for their collective behaviour to remain superparamagnetic at ambient conditions, despite the fact that a similarly sized particle of pure magnetic material, such as magnetite, would be ferrimagnetic (i.e as in the case of bulk magnetite) and would form aggregates with other particles. The invention can enable the formation of large superparamagnetic particles with large effective dipole moments when a magnetic field is applied, but with no magnetic coagulation at ambient conditions.

The outer shell further assists in binding the shell of magnetic nanoparticles firmly to the core and may advantageously protect the magnetic particles from the environment, for example to alleviate problems such as oxidation of the magnetic material. Oxidation of magnetite can result in a non-magnetic product which would be detrimental to the properties of the particle. The outer shell can also act as a barrier, for example preventing the diffusion of iron from the magnetic layer to a luminescent layer which may be provided (described below), which diffusion would cause quenching of the luminescence. The outer shell can form a smooth surface to the overall particle and can provide the overall particle with well-characterised surface properties. In this way, the resulting particle can have the effective surface properties of a non-magnetic particle, but the effective bulk properties of a superparamagnetic particle. The smooth outer shell can also be used as a base for deposition of an additional coating, such as a luminescent layer.

Advantageously the outer shell is a homogeneous material, as a result of its method of formation, for example by a sol-gel process, and provides a barrier to desorption of the magnetic nanoparticles and a barrier to attack from substances from the outside. A sol-gel coating outer shell can have some degree of porosity, but tailoring the thickness of the outer shell can mitigate the permeability of the shell to certain species.

Preferably the core size is in the range of 50 nm to 10 μm, for example 50 nm up to 100 nm, i.e. nanosize (in the case of a substantially spherical core this size would represent the diameter), and preferably the core comprises a non-magnetic material, such as silicon dioxide, titanium dioxide, yttrium oxide, yttrium basic carbonate, hematite, alumina, or any silicate.

Preferably the thickness of the shell of nanoparticles of magnetic material is in the range of from 2 nm to one fifth of the core size. Preferably the shell comprises a mono layer of nanoparticles and preferably the magnetic material comprises one or more selected from the group consisting of iron, cobalt, nickel, magnetite, maghemite and ferrite.

Preferably the particle may further comprise an inner shell between the core and the shell of nanoparticles of magnetic material. The inner shell can assist in binding the magnetic nanoparticles to the core. Preferably the inner shell comprises at least one layer of polyions which enable the binding to be predominantly electrostatic in nature. When the inner shell comprises a single layer of polymer, the core and the magnetic nanoparticles must be of the same net charge polarity and of opposite polarity to the inner shell. Alternatively, the inner shell can comprise a plurality of layers of polyions. This has the advantage of more reliably forming a continuous shell of polymer over the core, and hence binding an optimum amount of magnetic nanoparticles to the core. In the case of multiple layers of polyions, successive layers are of alternate polarity, such that each layer is electrostatically bound to the layer immediately underneath it. The charge on the innermost polymer layer must oppose the net charge on the core and the charge on the outermost polymer layer must oppose the net charge on the magnetic nanoparticles.

Preferably the thickness of the inner shell is in the range of from approximately 1 to 3 nm, and preferably the polyions are derived from one or more polyelectrolytes selected from the group consisting of poly(diallyldimethyl ammonium chloride) (polycations), poly(sodium styrene sulfonate) (polyanions), polyallylamine hydrochloride (polycations), and polyethylenimine (polycations).

Preferably the outer shell comprises a non-magnetic material, such as an inorganic oxide, basic carbonate or silicate, for example silicon dioxide, titanium dioxide, yttrium oxide, yttrium basic carbonate, or any silicate, and preferably the thickness of the outer shell is in the range of from approximately 1 to 200 nm.

A further functional coating can be provided on the particle, typically formed surrounding the outer shell.

Advantageously, the outer coating can comprise a shell formed from a metal, such as gold. The resulting particle exhibits a plasmon resonance, so absorbs electromagnetic radiation at particular frequencies. The wavelength of the plasmon resonance can be tuned by selecting the parameters of the particle, such as the thickness of the shell and the diameter of the particle.

Alternatively, the coating can advantageously comprise a luminescent material, such as an inorganic oxide such as a rare earth oxide doped with a luminescent ion, typically a rare earth, for example yttrium oxide doped with europium.

Another aspect of the invention provides a 1D chain comprising a plurality of particles described above.

A further aspect of the invention provides a process for preparing a magnetic particle, the process comprising:

a first step of providing a core;

a second step of adsorbing an inner shell to the core;

a third step of providing a plurality of nanoparticles of a magnetic material;

a fourth step of adsorbing the nanoparticles to the inner shell; and

a fifth step of providing or synthesizing an outer shell surrounding the particle.

This method according to the invention enables particles to be prepared having tailored physical properties, which exhibit the effective bulk properties of a superparamagnetic particle, and the effective surface properties of a non-magnetic particle.

Preferably the fourth step is carried out using a short-chain alcohol, e.g. of 1 to 6 carbon atoms such as ethanol, as solvent. The permittivity of the alcohol is less than that of water and the electrostatic interaction between the nanoparticles and the inner shell is stronger in this solvent, so a more tightly bound shell of nanoparticles can be formed. It has been found, though, that for smaller particles, eg. of nanoparticle size, it is generally necessary to dilute the particles in water and carry out the deposition in the aqueous phase and then redisperse the particles in the organic phase for outer shell growth. This is because it becomes difficult to separate aggregates of non-absorbed magnetic particles from solution when using coated core particles of a similar hydrodynamic size.

Preferably the fourth and fifth steps are carried out using the same solvent (except for nanoparticles). This is advantageous because it has been found that transferring the product of the fourth step to a different solvent for the fifth step can result in the agglomeration of the particles and the subsequent coating of aggregates, rather than individual particles, with an outer shell. Preferably the solvent for both the fourth and fifth steps is ethanol.

Preferably step 5 is carried out under ultrasonic agitation, for example as provided by an ultrasonic probe or by immersion of the reaction vessel in an ultrasonic bath. This alleviates agglomeration of the particles during the initial stages of their coating with the outer shell. Other agitation methods can fail to prevent agglomeration. Preferably the ultrasonic agitation is at relatively low frequency, such as a frequency in the range of from approximately 40 to 80 kHz.

Preferably the second step comprises adsorbing polyions provided from a solution of polyelectrolyte and an inorganic salt. Preferably the salt is water soluble. Preferably the salt is an alkali metal salt. Preferably the salt is an alkali metal halide such as potassium chloride or sodium chloride. The presence of the salt improves the flexibility of the polyions and hence allows better wrapping of the polymer round the core.

Advantageously the second step comprises layer by layer growth of polyions of alternate polarity to form the inner shell. In this way a more continuous inner shell can be formed to enable better binding of nanoparticles. The layers can be grown using electrostatic attraction whilst the particles remain stable with respect to aggregation.

Preferably said fourth step comprises mixing a solution of coated core particles derived from the second step with a solution of nanoparticles of magnetic material, wherein the number of core particles and number of nanoparticles in said mixed solutions are calculated such that substantially complete coverage of each core particle with a shell of nanoparticles is enabled.

Preferably, in said fifth step the amount of material to form the outer shell is calculated taking into account the desired thickness of the outer shell and the space between the nanoparticles of magnetic material. When making nanosized particles, though, the reaction kinetics tend to be such (they are much slower because the ratio of the reactants tends to be chosen more to avoid agglomeration than rapid reaction) that the reaction is stopped when the desired thickness has been obtained.

Embodiments of the invention will now be described, by way of example only, with reference to the accompanying drawings in which:

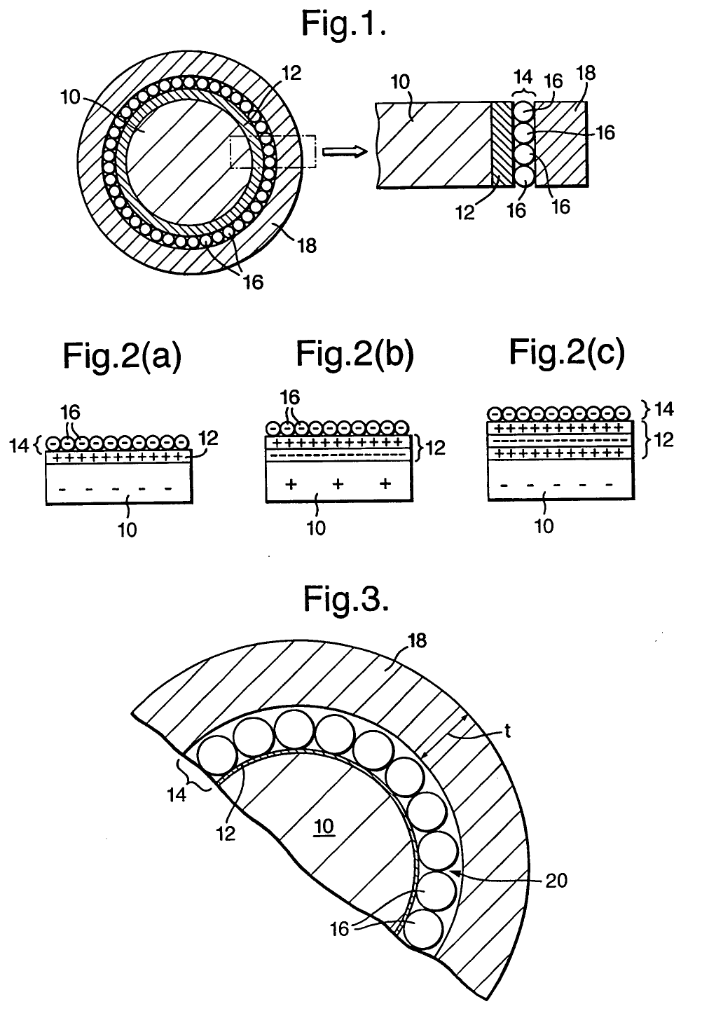

FIG. 1 depicts schematically a particle according to the present invention in cross-section, and an enlarged portion thereof;

FIG. 2 illustrates schematically examples of different possible structures for an inner shell;

FIG. 3 shows schematically a cross-section of a portion of a particle for assisting in explaining the optimal volume of outer shell material needed;

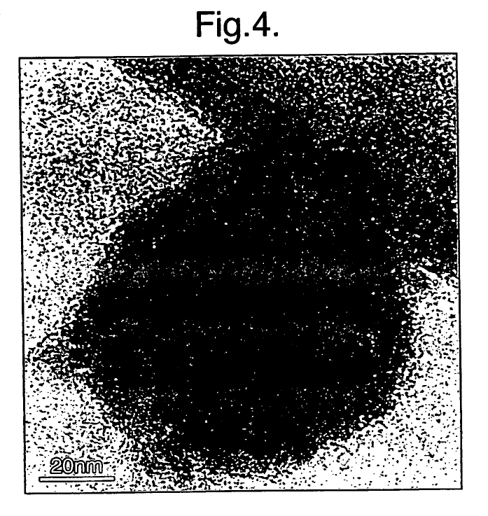

FIG. 4 is a TEM of a particle of the present invention.

Firstly will be described a particle embodying the invention, followed by a process according to an embodiment of the invention for preparation of particles, and then uses of particles according to the invention.

A particle embodying the invention is illustrated in FIG. 1. This and the other figures are purely schematic and not to scale so that the relative dimensions of the various components are not necessarily accurate, but merely for illustration. The left hand side of FIG. 1 shows a cross-section through the particle and the right hand side shows a detailed enlarged portion of the cross section.

The particle comprises a core 10 composed of silicon dioxide with a diameter of approximately 300 nm. The core 10 is surrounded by an inner shell 12 composed of polymer, and in particular polyions derived from dissociable polymers (polyelectrolytes). Examples of the structure of the inner shell are given below with reference to FIG. 2.

Surrounding the inner shell 12 is a shell 14 which comprises a plurality of nanoparticles 16. In this specific example, the nanoparticles are formed of magnetite (Fe₃O₄) and have a mean diameter of approximately 10 nm, but this is merely a non-limitative example. Preferred criteria to be satisfied by the magnetic nanoparticles are that they have a diameter less than one fifth of the diameter of core; they form a stable colloidal dispersion in water, and they possess a zeta potential of greater than 25 mV or less than −25 mV in water or ethanol.

Surrounding the shell 14 of nanoparticles 16 of magnetic material is an outer shell 18 of non-magnetic material, in this example silicon dioxide.

A further layer or coating (not shown) can be provided on the particle surrounding the outer shell 18. This coating can be functional, depending on the application to which the particle is to be put. According to one embodiment, the particle is provided with a coating of a shell of gold. The resulting particle has an absorption spectrum characteristic of that of a plasmon resonant particle with a dielectric core. By selecting the thickness of the shell and the diameter of the particle, the plasmon resonance can be tuned such that, for example, the position of the resonance can be anywhere from the visible part of the electromagnetic spectrum to the deep infrared. For larger cores and thicker shells, there will not be one simple resonance (dipole) but rather increasing contributions from higher order multiple resonances (quadrupole, octupole etc.). The higher order resonances have shorter wavelengths than the lower order ones.

Alternatively, the coating can comprise a luminescent material, such as yttrium oxide doped-with europium or yttrium silicate, such as for use as a phosphor in a display or for magnetic particle crack detection.

In another embodiment, the outer coating can provide biological functionality, for example by comprising a particular protein.

Returning to the structure of the inner shell 12, FIG. 2 depicts three different embodiments. In FIG. 2(a), where both the core 10 and the magnetic particles 16 are of the same charge polarity, for example anionic in the case of a silica core and magnetite particles, then a single layer of oppositely charged polymer could be used, for example poly(diallyldimethyl ammonium chloride) (PDADMAC). In the case in which the core 10 and magnetic particle shell 14 are of opposite polarity, then the inner shell 12 comprises two layers of opposite polarity, as shown in of FIG. 2(b). More layers can be provided in order to provide optimal binding of the magnetic particles. In general, where the core 10 and magnetic particles have the same polarity, the inner shell 12 comprises an odd number of layers, and where the core 10 and magnetic particle have opposite polarity, the inner shell 12 comprises an even number of layers. The polymer layers are adsorbed in a sequence of alternating charge polarities. The charge on the innermost polymer layer must be of opposite polarity to the charge on the core 10 and the charge on the outer most polymer layer must be of opposite polarity to the magnetic particles 16. For example, as shown in FIG. 2(c), to bind anionic magnetite nanoparticles to an anionic silica core 10, a three-layer inner shell 12 of polymer was used. This comprised an inner layer of PDADMAC, a layer of poly(sodium styrene sulfonate) (PSS) and an outer layer of PDADMAC.

According to a further embodiment, the particle can comprise a plurality of shells of nanoparticles of magnetic material. The additional shells of nanoparticles of magnetic material can be grown using a layer-by-layer process, as described below, and may optionally be separated by one or more, preferably greater than one, layers of polyions of appropriate polarity, as discussed above with reference to FIG. 2. A polyanion layer will, of course, be necessary if the core and the magnetic particle are both positively charged.

Again it is possible to incorporate one or more layers (shells) of nanoparticles of non-magnetic material under or over the shell(s) of magnetic material before the continuous outer shell. Such nanoparticles include metals such as gold or silver, a semiconductor material or a ceramic material such as CdSe₂ CdS, ceria and silica. Next, an embodiment of a method, according to the invention, for preparing magnetic particles will be described.

Step 1. Core Synthesis

Nanoparticles of silicon dioxide (silica) can be synthesised by the so-called “Stöber Process” by reaction between an alkoxy silane and an alkali such as ammonia, typically in a solvent such as ethanol (W. Stöber, A. Fink, E. Bohn, J. Colloid Interface Sci. 1968, 26, 62). Depending on several parameters, the resulting particles have a mean size of between 50 and 500 nm. Further Stöber growth on pre-existing cores can result in ripening of the nanospheres into microspheres and a narrowing of the size distribution. Hence, particles of pure silica are obtainable with mean sizes between about 50 nm and several microns. Other techniques such as miscible non-solvent addition to sodium silicate or microemulsion synthesis can be used to obtain diameters less than about 50 nm.

In a typical Stöber synthesis, 45 mL of dry absolute ethanol and 4.5 mL of 25% ammonia solution were stirred vigorously in a glass beaker. 1.5 mL of dry tetraethoxysilane was added rapidly to the beaker. Stirring was continued for 12 hours during which time the solution became turbid, indicating the formation of particles. Particle diameters were measured by dynamic light scattering (DLS) and transmission electron microscopy (TEM). According to both techniques, the distribution was bimodal with mean diameters of about 230 and 400 nm. This colloid was used to demonstrate that the magnetic nanoparticles could be adsorbed onto polydisperse cores. Highly monodisperse cores can be attained by careful tuning of the Stöber process reactants and conditions.

After formation of the silica particles, the colloid containing them was centrifuged at 3000 RCF for 30 minutes and the solid pellet redispersed in 50 mL absolute ethanol. This washing procedure was repeated two more times and then three times with a 1.3 mM aqueous solution of potassium chloride as the dispersant. The zeta potential of the silica colloid was measured by an electrophoresis technique. At a pH of approximately 6 the zeta potential was found to be typically −40 mV. The concentration of silica particles (in particles per volume) can be calculated assuming 100% yield and 10% particle porosity. For example, the concentration of the abovementioned particles after redispersion in 50 mL aqueous solution was 2.78×10¹¹ particles/mL.

Step 2. Inner Shell Growth: Polymer Coating

As an example of polymer coating by the layer-by-layer technique (R. A. Caruso, A. Susha, F. Caruso, Chem. Mat. 2001, 13, 400), three layers of polymer were adsorbed onto anionic silica particles with a zeta potential in 1.3 mM aqueous potassium chloride solution of −40 mV. The colloid was centrifuged at 3000 RCF for 30 minutes and the solid pellet was redispersed in 50 mL of a 1 mg/mL solution of poly(diallyldimethylammonium chloride) which also had a 0.1M concentration of potassium chloride. The presence of this salt is necessary to enable optimum flexibility of the polyions and hence wrapping of the individual colloidal particles. For smaller particles the molecular weight of the polyion should be lower such that the length of the polymer chain is less than the circumference of the particles to be coated, the molecular weight of the polyion preferably being less than 70000 for nanosized particles. The salt concentration should be increased to a value limited by the onset of electrolyte-induced coagulation of the core (e.g. up to 0.75M potassium chloride, preferably 0.5M potassium chloride in the case of silicon dioxide cores).

The colloid was left for between 30 minutes and 5 hours (preferably at least 3 hours) during which time the positive polyions adsorbed to the particles' surfaces. To remove non-adsorbed polyions the solution was centrifuged at 2000 RCF for at least 15 minutes and the solid pellet redispersed in 50 mL of 1.3 mM aqueous potassium chloride solution. This washing procedure was repeated two more times with longer centrifugation times of at least 30 minutes. The zeta potential of anionic silica nanoparticles coated with polydiallyldimethylammonium ions in 1.3 mM potassium chloride was measured to be about +38 mV.

To form a further polymer coating, the particles were centrifuged and redispersed in a 1 mg/mL solution of poly(sodium styrenesulfonate) which also had a 0.1M concentration of potassium chloride. The solution was left for between 30 minutes and 5 hours (preferably at least 3 hours). The subsequent washing step was identical to that carried out after the first polymer coating. The zeta potential of anionic silica nanoparticles coated with polydiallyldimethylammonium and polystyrenesulfonate ions in 1.3 mM potassium chloride was measured to be about −28 mV.

A third polymer coating, also of polydiallyldimethylammonium ions was formed by exact repetition of the procedure to form the first polymer coating the zeta potential of anionic silica nanoparticles coated with such a three-layer polymer coating was measured to be about +48 mV.

Step 3. Magnetic Nanoparticle Synthesis

Anionic nanoparticles of magnetic iron oxide were synthesised from a water soluble iron salt and ammonia by a co-precipitation method based on that originally reported by Massart (R. Massart, IEEE Trans. Magn. 1981, 17, 1247). Control over the iron oxide particle size can be achieved by adding small amounts of sodium citrate or by heating. 1.63 g iron (II) chloride tetrahydrate and 4.35 g iron (III) chloride hexahydrate were dissolved in 190 mL deionised water. Under vigorous stirring 10 mL of 25% aqueous ammonia solution was added. A black precipitate formed rapidly and was stirred for at least 10 minutes. The precipitate was separated by centrifugation and magnetic separation. The precipitate was redispersed in deionised water and washed two further times. To peptise the particles 3 mL of an 80% tetramethylammonium hydroxide solution was added. To remove any large aggregates, the colloid was filtered through a 0.2 micron PTFE membrane filter. The final colloidal particles had an estimated diameter of 10 nm and a concentration of approximately 1.67×10¹⁶ particles per mL.

Step 4. Intermediate Shell Formation: Magnetic Nanoparticle Attachment to Core

Magnetic nanoparticles of iron oxide synthesised as per step 3 were attached to silica cores synthesised and polymer coated as per steps 1 and 2. The approximate number of iron oxide nanoparticles required to coat a single silica sphere was calculated based on a geometrical model whereby polymer coatings are assumed to contribute negligibly to the core diameter and the iron oxide nanocrystals are spherical with a mean diameter of between 2 and 15 nm. For example, a core with diameter 328 nm would require 4303 nanoparticles of 10 nm diameter in order to filly coat it. In this simple model, the surface area of the core sphere is divided by the area of a circle of diameter equal to the mean diameter of the nanoparticles to give the approximate total number of nanoparticles required to fully coat the core. Given the concentration of cores and magnetic nanoparticles in solution this calculation enables the approximate calculation of quantities of each solution to cause complete coverage of cores by the intermediate shell nanoparticles.

To prepare the polymer coated cores for intermediate shell adsorption the core colloid was centrifuged at 2000 RCF for 30 minutes and the solid pellet redispersed in 50 mL absolute ethanol. This washing step was repeated twice further. At this point the iron oxide colloid is water-based whilst the inner-shell coated cores are in ethanol. Having calculated the correct amount of iron oxide colloid to add, the cores solution is firstly diluted with ethanol to a volume at least 10 times the volume of iron oxide colloid that will be added. This avoids agglomeration i.e. with the core solution being more dilute. The solution of the magnetic nanoparticles is then mixed with the solution of polymer coated cores. The mixture was stood for 30 minutes and then washed in ethanol three times.

Step 5. Outer Shell Growth

The outer shell can be grown by many existing sol-gel techniques; in this specific example, a modification of the core silicon dioxide (silica) synthesis procedure was used to allow the coating of the intermediate shell with a continuous shell of silica; the particles are dispersed in ammonia solution and the alkoxy silane added. To calculate the correct amount of silica to add, a geometrical model was employed. Referring to FIG. 3, assuming a required silica shell thickness of t it is necessary also to calculate the approximate “spare” volume 20 created by having a nanoparticulate intermediate shell. The spare volume 20 can be obtained by subtracting the total volume of the nanoparticles 16 from the volume of a spherical shell of thickness equal to the mean diameter of the nanoparticles 16. For example, a colloidal suspension of nanoparticles was produced as described in steps 1-4 above with a mean core diameter of 313 nm and an intermediate shell nanoparticle mean diameter of 10 nm. In order to form a 10 nm thick outer shell, it was necessary to add 1.3 times the amount of silica needed for the actual shell. An example of this outer shell growth involved coating of a 10 mL solution of 328 nm diameter intermediate shell particles (concentration=8.3×10¹⁰ part/mL) with a 18 nm thick shell by diluting the particles with 35 mL of dry absolute alcohol and 1.6 mL 25% ammonia solution. The solution was sonicated for 1 hour, followed by 1 hour standing, in a Decon FS100b ultrasonic bath during the shell growth, which was initiated by adding 0.37 mL of tetraethoxysilicate solution. The particles were then washed 3 times in ethanol and 3 times in 1.3 mM potassium chloride solution.

A thicker outer shell 18 can be built up in layers, for example by repeating the above sol-gel process to add 25 nm thick layers at a time.

Further Embodiments

A further embodiment of the invention will now be described in which a metal coating is provided on the magnetic particle. The magnetic particles synthesised as described in Steps 1-5 were coated with gold, desirably after one or more layers of polyions have been deposited. A layer of polydiallyldimethylammonium ions were adsorbed onto the outer shell of the particles formed in step 5. Anionic gold nanoparticles with mean diameter of 2 nm were produced by a method of Duff (D. G. Duff, A. Baiker, P. P. Edwards, Langmuir 1993, 9, 2301) and were attached to polycation layer by electrostatic attraction. The gold colloid decorated particles were then redispersed in a coating solution. The coating solution was a one-day aged solution of 25 mg potassium carbonate and 1.5 mL of 25 mM chloroauric acid in 100 mL of water. The amount of solution required was calculated so that growth of the colloidal gold seed particles would coalesce to form a complete shell. To cause this coalescence, a reducing agent such as sodium borohydride, formaldehyde or hydroxylamine hydrochloride was used. The resulting particles had an absorbtion spectrum characteristic of that of a plasmon resonant article with a dielectric core.

Another embodiment of the invention is to coat the magnetic particles with a luminescent material according to the following method. The magnetic nanoparticles synthesised as described in Steps 1-5 were coated with europium-yttrium basic carbonate. This particle could then be heat treated to form magnetic nanoparticles that emit visible light. In one embodiment a rare earth doped oxide, in this case europium-doped yttrium oxide, is formed in situ on the particles. This can be achieved by immersing the particles in an aqueous solution of salts of yttrium and europium along with urea or other compound which decomposes under the reaction conditions and forms a basic carbonate and heated. The basic carbonate which first forms can then be converted into the doped oxide by calcination. For this purpose the outer shell coated particles were aged at 90° C. in a 16 mM yttrium chloride, 0.8 mM europium chloride and 0.48M urea solution. The amount of this solution needed was calculated based on the thickness of shells required and the concentration of the outer shell particles. Coatings as thick as 150 nm could be prepared this way. The particles were washed and dried and then calcined at up to 600° C. to convert the coating to yttrium oxide doped with europium.

Another method embodying the invention is to dry solutions of particles according to the invention in the presence of a linear magnetic field. The particles will spontaneously align into 1D chains which can act as nanowires.

Applications of particles according to this invention include utilising the fact that the particles exhibit the superparamagnetic effect and so respond to a magnetic field gradient and tend to line up along magnetic field lines. This enables the particles to be manipulated and also to affect fluid properties, such as viscosity. Thus the particles could be utilised in a drug delivery vehicle, either in vivo, or as part of a fixed system which releases drug in response to a magnetic field. Particles could also be utilised in cell sorting. Other biomedical uses include as a magnetic resonance imaging contrast agent and a magneto-optic bio-tag. Opto-electronic applications include use of appropriately coated particles as a phosphor, and plasmon resonant particles, such as those with a gold coating, can be used as a waveguide to allow energy to be transmitted, for example for coupling into an optical fibre. Tuning of the plasmon resonance to the near infrared can enable the particles to absorb energy subcutaneously to provide a heating effect, such as for drug-delivery. Furthermore, solutions of magnetic particles with a gold coating have been found to display enhanced birefringence (compared with non-resonant magnetic particles) in the presence of a magnetic field at wavelengths close to their dipole resonance. This could form the basis of a sensitive probe of the kinetics of biological binding reactions.

Particles according to the invention also have applications in mechanical engineering, such as for crack detection using magnetic particles coated with phosphor or other fluorescent material.

Particles according to the invention are potentially useful in all applications which already utilise pure particles of the material which forms tie outer shell (for example silicon dioxide). The added inherent magnetic properties may therefore add value to such applications.

The following Example further illustrates the present invention.

Part (a)

This Part describes the coating of commercial anionic silica particles smaller than 100 nm with a three layer shell of polyions. The colloidal silica used was Morisol W30 (Morrisons Chemicals, UK) and was used as received. Electron microscopy revealed this to be a rather bidisperse sol containing spheroidal particles with average sizes of approximately 30 and 70 nm. As a result of the processing described (centrifugation speed, time) only particles of the latter size were retained. 0.5 mL of silica sol was diluted with 4.5 mL water. To this was slowly added 1 mL of a 3M potassium chloride solution. This sol was added slowly to a 6 mL solution of 0.5M potassium chloride and 50 mg of very low molecular weight poly(diallyldimethylammonium chloride) (Sigma Aldrich #52,237-6). The sol was agitated in an ultrasonic bath for 1 minute and then stood for 30 minutes. The sol was washed by centrifugation (7000 RCF, 30 minutes) and the clear supernatant discarded. This washing was repeated three times and after the third wash the particles were resuspended in 5 mL water. To this was slowly added 1 mL of a 3M potassium chloride solution. The sol was then added slowly to a 6 mL solution of 0.5M potassium chloride containing 50 mg of poly(sodium styrenesulfonate) (Sigma Aldrich #24,305-1). The sol was agitated in an ultrasonic bath for 1 minute and then stood for 30 minutes. The sol was washed three times by centrifugation as detailed above. After the third wash the particles were resuspended in 5 mL water and 1 mL of a 3M potassium chloride solution was slowly added. The above procedure for coating with poly(diallyldimethylammonium chloride) was repeated followed by the usual washing routine. After the final centrifugation the particles were resuspended in 6 mL water. The zeta potential of the sol was measured by electrophoretic method to be +50 mV.

Part (b)

The polyion-coated silica particles synthesised according to Part (a) were coated with iron oxide particles obtained as in Step 3 above in a similar manner to the step 4 above except that the coating took place in water since non-adsorbed aggregates of iron oxide which formed when ethanol was used were hard to separate from solution when using silica cores of a similar hydrodynamic size to the aggregates. 2 mL of silica sol was diluted with 4 mL water and mixed with 2.5 mL of iron oxide sol that has been diluted with 3.5 mL water. The mixture was agitated for 1 minute in an ultrasound bath and then stood for 1 hour. The sol was centrifuged, the clear brown supernatant discarded and the pellet resuspended in water. After centrifuging again, the pellet was redispersed in ethanol. Washing by centrifugation and resuspension continued until supernatant was on longer coloured. After final wash the particles were redispersed to 12 mL in ethanol.

Part (c)

The iron oxide coated particles synthesised according to Part (b) were coated with a further outer shell of silicon dioxide. 3 mL of the iron oxide coted particles were diluted with 8 mL ethanol in glass beaker. 100 μL of dry tetraethoxysilane was added. To this was added, under ultrasonic agitation, 5.2 mL water, 3.4 mL ethanol and 224 μL 25% ammonia solution. Agitation continued for 1 minute after which the beaker was removed. The silica shell grew slowly over several hours without aggregation of the particles. After approximately 24 hours the sol was washed 4 times by centrifugation and resuspension. The first resuspension was carried out in a 3:1 ethanol: water mixture. Subsequent resuspensions were carried out in water. The zeta potential of the sol was measured to be −50 mV and TEM revealed a thin <5 nm amorphous coating of silicon dioxide on the particles as shown in FIG. 4 (Scale bar=20 nm). The thickness of the shell could be adjusted by initially adding more tetraethoxysilane or leaving the coating solution to stand for a longer time.

1. A particle comprising a core surrounded by a shell which comprises a plurality of nanoparticles of a magnetic material, the shell being surrounded by a continuous outer shell which comprises a non-magnetic material.

2. A particle according to claim 1, wherein the core size is in the range of from 50 nm to 10 μM.

3. A particle according to claim 1, wherein the core comprises a non-magnetic material.

4. A particle according to claim 1, wherein the core comprises at least one of silicon dioxide, titanium dioxide, yttrium oxide,. yttrium basic carbonate, hematite, alumina and a silicate.

5. A particle according to claim 1, wherein the thickness of the shell of nanoparticles of magnetic material is in the range of from 2 nm to one fifth of the core size.

6. A particle according to claim 1, wherein the shell comprises a monolayer of nanoparticles.

7. A particle according to claim 1, wherein the magnetic material comprises one or more selected from the group consisting of iron, cobalt, nickel, magnetite, maghemite and ferrite.

8. A particle according to claim 1, further comprising an inner shell between the core and the shell of nanoparticles of magnetic material.

9. A particle according to claim 8, wherein the thickness of the inner shell is in the range of from approximately 1 to 3 nm.

10. A particle according to claim 8, wherein the inner shell comprises at least one layer of polyions.

11. A particle according to claim 8, wherein the inner shell comprises a plurality of layers of polyions, and wherein the polyions of successive layers are of alternating polarity.

12. A particle according to claim 8, wherein polyions comprising the inner shell are derived from one or more polyelectrolytes selected from the group consisting of poly(diallyldimethyl ammonium chloride), poly(sodium styrene sulfonate), polyallylamine hydrochloride, and polyethylenimine.

13. A particle according to claim 12, wherein the thickness of the outer shell is in the range of from approximately 1 to 200 nm.

14. A particle according to claim 12, wherein the outer shell comprise at least one of silicon dioxide, titanium dioxide, yttrium oxide, yttrium basic carbonate and a silicate.

15. A particle according to claim 1, further comprising a coating over the outer shell selected from the group consisting of a metal and a luminescent material.

16. A particle according to claim 15, wherein said metal comprises gold.

17. A particle according to claim 15, wherein said luminescent material comprises yttrium oxide doped with europium.

18. A particle according to claim 1, comprising a plurality of shells of nanoparticles of magnetic material.

19. A 1D chain comprising a plurality of particles according to claim 1.

20. A process for preparing a magnetic particle comprising: a first step of providing a core; a second step of adsorbing an inner shell to the core; a third step of providing a plurality of nanoparticles of a magnetic material; a fourth step of adsorbing the nanoparticles to the inner shell; and a fifth step of providing an outer shell surrounding the particle.

21. A process according to claim 21, wherein the fourth step is carried out using a short-chain alcohol or water as solvent.

22. A process according to claim 22, wherein the solvent is ethanol.

23. A process according to claim 20, wherein the fourth and fifth steps are carried out using the same solvent.

24. A process according to claim 20, wherein the fifth step is carried out under ultrasonic agitation.

25. A process according to claim 24, wherein the ultrasonic agitation is at a frequency in the range of from approximately 40 to 80 kHz.

26. A process according to claim 20, wherein the second step comprises adsorbing polyions provided from a solution of polyelectrolyte and an inorganic salt.

27. A process according to claim 20, wherein the second step comprises layer by layer growth of polyions of alternate polarity to form the inner shell.

28. A process according to claim 20, wherein said fourth step comprises mixing a solution of coated core particles derived from the second step with a solution of nanoparticles of magnetic material, wherein the number of core particles and number of nanoparticles in said mixed solutions are calculated such that substantially complete coverage of each core particle with a shell of nanoparticles is enabled.

29. A process according to claim 20, wherein in said fifth step the amount of material to form the outer shell is calculated taking into account the desired thickness of the outer shell and the space between the nanoparticles of magnetic material.

30. A process according to claim 20, wherein the fifth step comprises using a sol-gel method to produce the outer shell.

31. A process according to claim 20, further comprising forming a functional coating surrounding the outer shell of the particle.
